(19) United States
(12) Patent Application Publication
(10) Pub. No.: US 2007/0226201 A1
(43) Pub. Date: Sep. 27, 2007

(54) Obtaining user feedback in a networking environment

(75) Inventors: Cameron B. Lerum, Renton, WA (US); Catherine A. Wissink, Medina, WA (US); Emma L. Archer, Sammamish, WA (US); Roxanne M. Seubert, Bellevue, WA (US); Sushmita Subramanian, Redmond, WA (US); Vivek R. Rao, Bellevue, WA (US); Yaron Hezroni, Bellevue, WA (US)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(73) Assignee: Microsoft Corporation, Redmond, WA (US)

(21) Appl. No.: 11/388,678

(22) Filed: Mar. 24, 2006

(51) Int. Cl. G06F 17/30

(52) U.S. Cl. 707/4

(57) ABSTRACT

As a user interacts with a program, an object may be presented that, when invoked, allows the user to provide feedback about content encountered when using a program. In accordance with one embodiment, a method is provided that collects feedback from the user at a centralized computer system. The method includes allowing a user to generate an event in order to provide feedback while using a program. In response to the event being generated, the method collects a set of data that includes (1) contextual data from which the source of the content may be identified; (2) the identity of the content selected by the user; and (3) user generated feedback that describes an issue with the content. Then, the set of data is communicated from a computer associated with the user to a centralized computer system.

### BACKGROUND

The constant progress of computer systems, particularly the explosion of the Internet and intranet networks, has resulted in the development of a new information era. With a single personal computer, a user may employ computer programs that perform a variety of tasks and provide access to a wide range of resources, information, and services. Moreover, software vendors and other content providers are increasingly able to obtain information from users over computer networks that describe the functionality and/or content in a program.

Many software vendors develop computer programs that contribute to the constant progress of computer systems. Those skilled in the art and others will recognize that computer programs are typically designed for users who employ a particular language and/or maintain a common background. Increasingly, computer programs that are designed for one group of users are modified to service the needs of users who employ a different language and/or have a different background. In this example, programs may include user interfaces and/or content in a variety of languages and/or formats. When user preferences are identified, a program or operating environment may be localized to a language/format that is configured for the intended recipient. Similarly, content, such as Web pages, may also be translated into a variety of formats to service different users.

Software vendors and other content providers may produce content that is inaccurate, formatted incorrectly, or inappropriate for a group of intended users. For example, under the present system in which programs are created for a first group of users and then modified to service the needs of other groups of users, the modification process exposes a program to several potential error sources. Also, software services are increasingly being used that automate the process of translating content between different languages. For example, a user viewing a Web page in one language may cause a software service to translate the Web page into a different language and have the translation displayed. However, modifying programs and/or content by, for example, performing a translation between different languages, is a complex task that may not be performed accurately either by a human translator or a software service.

In traditional systems, users are unable to easily report content encountered in a computer program that is inaccurate, formatted incorrectly, or inappropriate for a group of intended users. For example, when a user encounters content that was inaccurately translated, a user may be required to identify the specific software vendor that is responsible for the translation and contact the vendor via e-mail, telephone, etc. When a user reports an error in this way, developers may not be able to easily obtain a context in which the error was encountered. For example, a user may not accurately record the circumstances in which the error was encountered, thereby making it difficult or impossible for a developer to reproduce the error and/or perform the necessary actions to correct the error.

### SUMMARY

Aspects of the present invention are directed at obtaining feedback from one or more users. More specifically, as a user interacts with a program, an object may be presented that, when invoked, allows the user to provide feedback about content encountered by the user. In accordance with one embodiment, a method is provided that collects feedback from a plurality of users at a centralized computer system. More specifically, the method includes allowing a user to generate an event in order to provide feedback while using a program. In response to the event being generated, the method collects a set of data that includes (1) contextual data from which the source of the content may be identified; (2) the identity of the content selected by the user; and (3) user generated feedback that describes an issue with the content. Then, the set of data is communicated from a computer associated with the user to the centralized computer system.

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

### DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 is an exemplary pictorial depiction of a networking environment that includes a server computer and a plurality of client computers in which aspects of the present invention may be implemented;

FIG. 2 is an exemplary block diagram of the server computer and client computer illustrated in FIG. 1 with components that are configured to implement aspects of the present invention; and

FIG. 3 is an exemplary flow diagram that illustrates a routine or method for obtaining feedback from a user.

### DETAILED DESCRIPTION

Aspects of the present invention may be described in the general context of computer-executable instructions, such as program modules, being executed by a computer. Generally described, program modules include routines, programs, applications, widgets, objects, components, data structures, and the like, that perform particular tasks or implement particular abstract data types. Moreover, the present invention will typically be implemented in distributed computing environments where tasks are performed by remote processing devices that are linked through a communications network. In a distributed computing environment, program modules may be located on local and/or remote computer storage media.

Generally described, the present invention is directed at systems and methods for obtaining feedback from a user that describes issues (e.g., errors, inaccuracies, unexpected behavior, etc.) encountered in a program. More specifically, in accordance with one embodiment, a GUI object is provided that allows a user to provide feedback about content encountered in a program. When the user generates an event using the object, the present invention collects a set of data that includes the identity of the content selected by the user and a description of the issue. Then, the set of data is communicated from a computer associated with the user to a centralized computer system. As a result, when an issue, such as an error in a program, is encountered, a user is not required to identify or contact a software vendor that is responsible for the error. Moreover, when a user reports an error using the present invention, the context associated with the error is automatically forwarded to a trusted entity.

Although the present invention will be described with relation to illustrative user interfaces and operating environments, one skilled in the relevant art will appreciate that the disclosed embodiments are illustrative in nature and should not be construed as limiting. In any event, the following description first provides a description of an environment and system in which aspects of the present invention may be implemented. Then a method or routine that implements aspects of the invention is described. The illustrative examples described herein are not intended to be exhaustive or to limit the invention to the precise forms disclosed. Similarly, any steps described herein may be interchangeable with other steps or combinations of steps in order to achieve the same result.

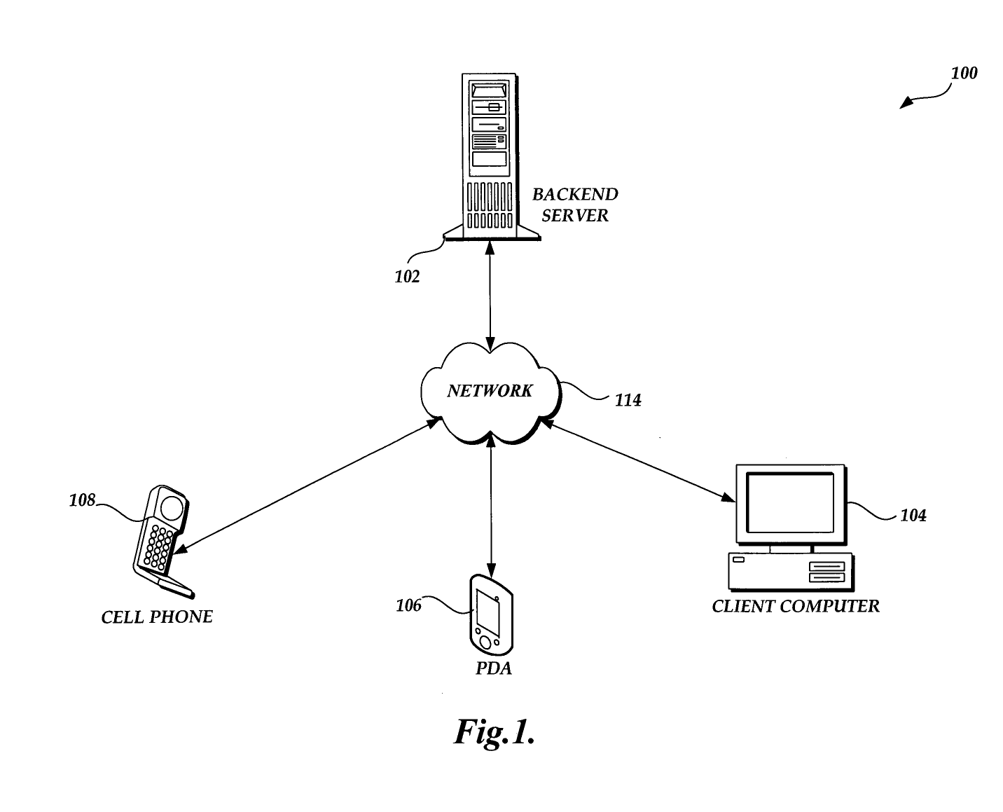

The following discussion is intended to provide a brief, general description of a networking environment 100 in which the present invention may be implemented. As illustrated in FIG. 1, the networking environment 100 is comprised of a plurality of computers, namely, the backend server 102, the client computer 104, the personal digital assistant (“PDA”) 106, and the cell phone 108. The backend server 102 is configured to communicate with the client computer 104, PDA 106, and the cell phone 108, via the network 114, which may be implemented as a Local Area Network (“LAN”), Wide Area Network (“WAN”), or the global network commonly known as the Internet. As known to those skilled in the art and others, the computers 102, 104, 106, and 108 illustrated in FIG. 1 may be configured to exchange files, commands, and other types of data over the network 114. However, since protocols for network communication, such as TCP/IP, are well known to those skilled in the art of computer networks, those protocols will not be described here.

For the sake of convenience, FIG. 1 illustrates a server computer, a client computer, a PDA, and a cell phone that are usable in the networking environment 100 in which complementary tasks may be performed by remote computers linked together through the communication network 114. However, those skilled in the art will appreciate that aspects of the present invention may be practiced with many other computer system configurations. For example, the present invention may be practiced with a personal computer operating in a stand-alone environment or with multiprocessor systems, minicomputers, mainframe computers, and the like. In this regard, the functions performed by the computers described herein may be implemented by a plurality of computers. For example, while the backend server 102 is illustrated as a single computer, server-based tasks are frequently implemented in a “server farm” in which multiple computers cooperate in executing necessary tasks. Moreover, in addition to the conventional computer systems illustrated in FIG. 1, those skilled in the art and others will also recognize that the present invention may be practiced on other kinds of computers, including laptop computers, tablet computers, or any device on which computer software or other digital content may be executed.

When software that performs the functions of the present invention is implemented in a networking environment, such as the networking environment 100 illustrated in FIG. 1, the software provides a way for users to easily provide feedback to developers that describes issues with programs so that improvements to the programs may be implemented. Moreover, data that provides a context for an issue is automatically collected and aggregated together at a central location. By aggregating data obtained from a plurality of users at a central location, developers may reproduce errors and easily identify and/or prioritize improvements to programs that will be implemented.

As will be appreciated by those skilled in the art and others, FIG. 1 provides a simplified example of one networking environment 100 suitable for implementing aspects of the present invention. In other embodiments, the functions and features of the computing systems shown (e.g., the backend server 102, the client computer 104, the PDA 106, and the cell phone 108) may be implemented using a greater number of computing systems or reduced to a single computing system and thus not require network protocols for communication between combined systems.

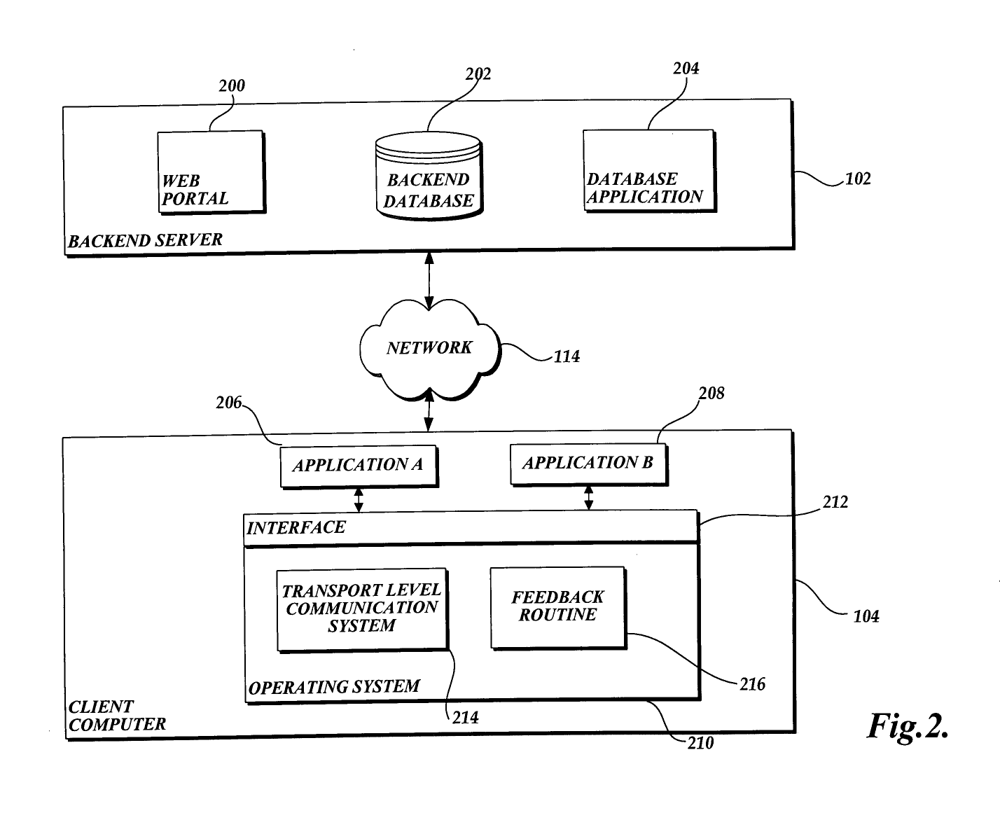

Now with reference to FIG. 2, exemplary computer architectures for the backend server 102 and the client computer 104 also depicted in FIG. 1 will be described. The exemplary computer architectures for the backend server 102 and the client computer 104 may be used to implement one or more embodiments of the present invention. For ease of illustration and because it is not important for an understanding of the claimed subject matter, FIG. 2 does not show the typical components of many computers, such as a CPU, keyboard, a mouse, a printer, or other I/O devices, a display, etc. However, as illustrated in FIG. 2, the backend server 102 does include a Web portal 200, a backend database 202, and a database application 204. Moreover, the client computer 104 includes “APPLICATION A” 206, “APPLICATION B” 208, and an operating system 210. Moreover, in this embodiment, the operating system 210 includes an interface 212, a transport level communication system 214, and a feedback routine 216.

In accordance with one embodiment, a computer associated with a user maintains “client-based” software that implements aspects of the present invention. Conversely, a computer system associated with a trusted entity such as an operating system provider or other software vendor maintains “server-based” software for obtaining and managing data received from users connected to the network 114. In the context of FIG. 2, the client computer 104 executes the client-based software and the backend server 102 executes the server-based software so that data that describes an issue with a program may be collected at a central location.

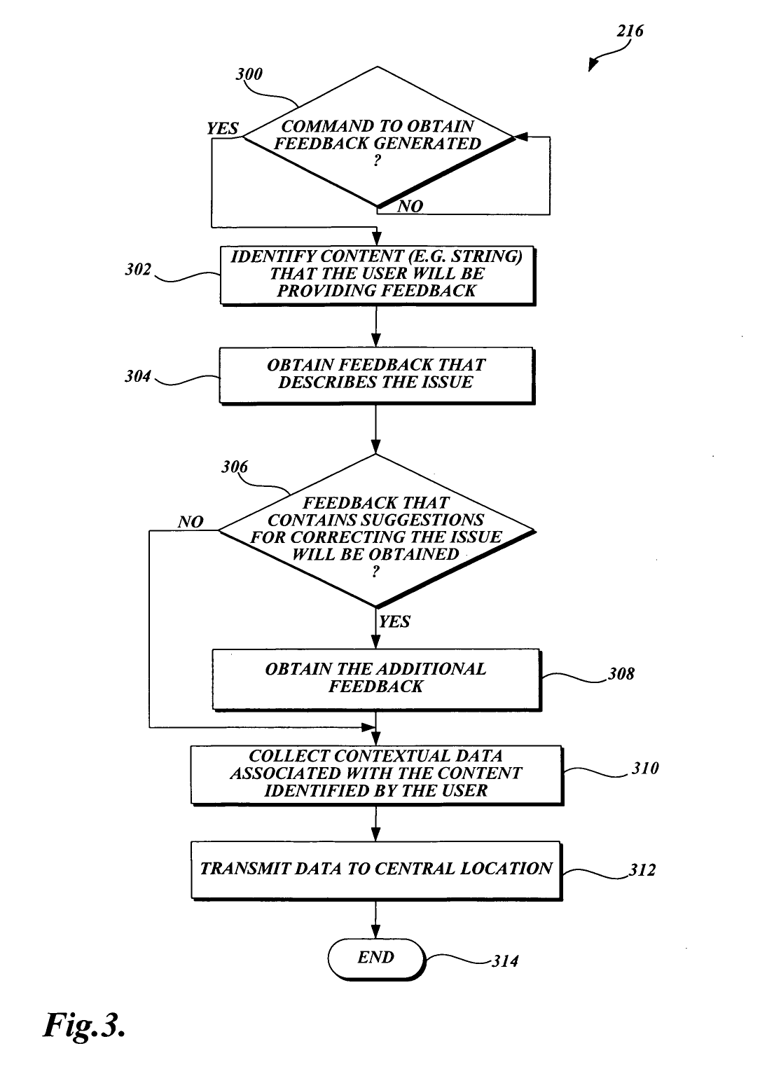

As illustrated in FIG. 3, the client computer 104 includes an operating system 210 that may be a general-purpose operating system, such as a Microsoft® operating system, UNIX® operating system, or Linux® operating system. Alternatively, the operating system 210 may be a specialized operating system designed specifically for a computer that maintains non-generic hardware. In any event, the operating system 210 controls the general operation of the client computer 104 and is responsible for executing programs. Moreover, the operating system 210 provides services to programs installed on the computer such as “APPLICATION A” 206 and “APPLICATION B” 208 that typically include certain core services including, but not limited to, input/output memory management, process scheduling, and the like. Typically, services provided by the operating system 210 are accessible using the interface 212 which maintains a set of library routines and/or other callable functions.

As further illustrated in FIG. 2, the operating system 210 on the client computer 104 includes a feedback routine 216 that contains software routines and logic implemented by aspects of the present invention. Since the feedback routine 216 is described below with reference to FIG. 3, a detailed description of the routine 216 will not be provided here. However, generally described, the routine 216 is event driven in that it is executed when a GUI object is invoked by a user. In accordance with one aspect of the present invention, a host program (e.g., “APPLICATION A” 206 and “APPLICATION B” 208) may instantiate a GUI object from an object-oriented class in which objects or instances of the class may be created. The GUI object may be presented to the user in any number of different contexts depending on the configuration of the host program. For example, a program developer may cause the GUI object to be presented on a dialog box, pop-up window, menu, hypertext document, and the like. The user may activate the GUI object by, for example, generating a pointer selection event (e.g., mouse click) where the GUI object is displayed, issuing a key stroke or combination of keystrokes (e.g., “hotkeys”), or otherwise inputting an appropriate command into a computer system that is supported by the present invention. Generally described, when the GUI object is selected, the feedback routine 216 handles the event by collecting a set of data that includes feedback provided by the user. Then, the set of data is communicated from a computer associated with the user to a central location where the data is accessible to developers.

As further illustrated in FIG. 2, the backend server 102 includes a backend database 202. When the feedback routine 216 handles an event, a set of data is transmitted from the client computer 104 over the network 114 to the backend server 102 where the data is stored in the backend database 202. In this regard, the feedback routine 216 uses the transport level communication system 214 to transmit the data to the backend server 104. Generally described, the backend database 112 receives data from disparate computers connected to the network 114. Moreover, the data stored in the backend database 114 may be aggregated into different “views” to assist developers to, among other things, identify errors or “bugs” in programs. In this regard, the backend server 102 includes a database application 204 that is configured to sort, arrange, or otherwise manipulate data in the backend database 202 to create the different views. For example, one view may be directed at identifying the number of users who reported the same error. If a high number of users reported the same error, a strong heuristic indicator exists that a software update should be provided to correct the error. In this way, collecting data from different users and sorting the data using the database application 204 provides a way for developers to prioritize between improvements that will be made to a program.

As further illustrated in FIG. 2, the backend server 200 includes a Web portal 200 that provides a two-way channel of communication between a trusted entity associated with the backend server 102 and a user. On one hand, the Web portal 200 is the software component on the backend server 102 that is responsible for receiving data from client computers and causing the data to be stored in the backend database 202. On the other hand, the Web portal 200 allows a user to access information about issues submitted to the trusted entity. For example, in accordance with one embodiment of the present invention, when a user provides feedback about content in a program, an identifier is assigned to the issue. Then the user may navigate to a Web site provided by the Web portal 200 and track the status of the reported issue. For example, developers may create a software update that fixes an error reported by a user. In this instance, when the user navigates to the Web site provided by the Web portal 200, this type of information may be accessed by the user. However, those skilled in the art and others will recognize that the example described above is exemplary, as other types of information may be provided by developers and accessed by the user from the Web portal 200.

Those skilled in the art and others will recognize that the backend server 102 and the client computer 104 illustrated in FIG. 2 are highly simplified examples that only illustrate components necessary for an understanding of the claimed subject matter. In actual embodiments of the present invention, the backend server 102 and the client computer 104 will have additional components that are not illustrated in FIG. 2.

Now with reference to FIG. 3, an exemplary embodiment of the feedback routine 216 mentioned briefly above with reference to FIG. 2 that is configured to collect data from users and submit the data to a central location (e.g., the backend server 102) will be described.

As illustrated in FIG. 3, the feedback routine 216 begins at decision block 300 where the routine 216 remains idle until an event is generated. As mentioned previously and in accordance with one embodiment, the feedback routine 216 is executed when a user activates a GUI object provided by the present invention. For example, modern programs typically include a “help window” that assists users in “troubleshooting” problems encountered when interacting with a program. In some instances, the content of the help window is translated from a different language using either a human translator or an automated software system. As a result, the content may contain errors or be inappropriate for the current user. Thus, a program developer may include a GUI object provided by the present invention on the help window in order to obtain feedback from the user. By way of another example, a Web site developer or other content provider may include a GUI object provided by the present invention inside a Web page. By activating the GUI object, a user may submit feedback about the content presented on the Web page. In any event, when the GUI object provided by the present invention is selected, the feedback routine 216 proceeds to block 302.

At block 302, the content that the user will be providing feedback about is identified. In accordance with one embodiment, when the GUI object provided by the present invention is selected, the user is prompted to identify the content in which feedback will be provided. Typically, the content is a text-based string that is currently presented to the user inside a program, Web page, etc. In this instance, the user may identify the content, at block 302, using a highlighting technique wherein the relevant string of text is selected using a mouse or other input device. In another embodiment, the user may identify the content by “hovering” the pointer over the relevant text and selecting the text with a pointer activation event. Moreover, the user may select non-text based content such as menus, buttons, windows, dialog boxes, using the same type of techniques.

As illustrated in FIG. 3, at block 304, the routine 216 obtains feedback that describes the issue identified by the user. In one embodiment, a menu is presented when the user identifies the relevant content that contains selectable menu items for classifying the issue identified by the user. By way of example only, some of the selectable menu items may be entitled “translation error,” “incorrect formatting,” “political issue,” “program error,” etc. However, aspects of the present invention are configurable in that other selectable menu items may be presented, at block 304, depending on the current program, the content identified by the user, and the like. In any event, the menu displayed at block 304 provides a way for the user to provide feedback that classifies the issue. Moreover, the menu also provides a mechanism for manual entry of text-based feedback into a textbox. In this way, a user may enter a description of the issue instead of or in addition to classifying the issue using selectable menu items. So, for example, the user may select the menu item entitled “program error” and then enter text that describes the error that was encountered.

At decision block 306, the feedback routine 216 determines whether additional feedback will be obtained. In accordance with one embodiment, a user may or may not provide additional feedback once the description of an issue is obtained. For example, if the user selects a particular menu item, a prompt may or may not be presented that requests additional feedback about the issue identified by the user. In any event, if additional data will be obtained, the feedback routine 216 proceeds to block 308. Conversely, if additional data will not be obtained, the feedback routine 216 proceeds to block 310 described in further detail below.

As illustrated in FIG. 3, at block 308, the feedback routine 216 obtains additional feedback about the issue identified by the user. For example, if the user selected the menu item entitled “translation error” presented at block 304, a prompt, textbox, or other GUI element may be used to obtain additional feedback regarding how to correct the translation error. Obviously, in this example, the user may enter a suggested modification to text that was presented. In this way, developers are able to collect suggestions that describe ways in which an issue may be corrected. However, those skilled in the art and others will recognize that other types of data useful in correcting or improving a program may be obtained at block 308, and the example provided above should be construed as exemplary and not limiting. Moreover, in other embodiments, all of the feedback obtained from the user may be submitted at the same time. Thus, the sequential description of how the feedback routine 216 collects data from the user is one embodiment, but other embodiments are possible.

At block 310, the feedback routine 216 collects contextual data that is associated with the content identified by the user at block 302. Those skilled in the art and others will recognize that content identified by the user is implicitly associated with a set of contextual data or information that may be used to identify the source of the content. For example, some of the contextual data collected at block 310 may include, but is not limited to, the exact version of the operating system installed on the computer, the identity and version of the program that presented the content, a resource identifier for the content, and/or files, dialogs and strings that are associated with the content, etc. At block 310, certain files and databases may be accessed to collect the contextual data. For example, a system registry is one illustrative example of a database that stores contextual data that may be accessed at block 310.

At block 312, the user generated feedback and contextual data is transmitted to a computer system associated with a trusted entity. For example, data generated from a computer associated with a user (e.g., the client computer 104) may be transmitted over a network connection to the backend server 102 and stored in the backend database 202. However, since transmitting data over a network connection for storage in a database may be performed using techniques that are generally known in the art, further description of these techniques will not be provided here. Then the feedback routine 216 proceeds to block 314, where it terminates.

Generally described, the feedback routine 216 provides a convenient way for users to submit feedback that describes an issue in the execution path of the program. Moreover, by implementing the feedback routine 216 in a networking environment, data generated at a plurality of client computers may be aggregated together at a central location. The data collected may be used in a number of ways. For example, using contextual data obtained by the feedback routine 216, existing systems may be used to “map” the issue identified by the user to an entity (e.g., software vendor, development team, or individual developer) that is responsible for handling the issue. However, those skilled in the art and others will recognize that the data collected by the present invention may be used in other ways than those described herein without departing from the scope of the claimed subject matter.

While illustrative embodiments have been illustrated and described, it will be appreciated that various changes can be made therein without departing from the spirit and scope of the invention.

The embodiments of the invention in which an exclusive property or privilege is claimed are defined as follows:

1. In a networking environment that includes a computer system for collecting data from a plurality of sources and a computer associated with a user, a computer-implemented method of obtaining feedback from the user, the method comprising:
(a) allowing the user to generate an event while using a program to provide feedback;
(b) in response to the event being generated, collecting a set of data that includes:
(i) contextual data from which the source of the content may be identified;
(ii) content selected by the user;
(iii) user-generated feedback that describes an issue with the content selected by the user; and
(c) communicating the set of data from the computer associated with the user to the computer system that collects data from a plurality of sources.

2. The method as recited in claim 1, further comprising:
(a) receiving the set of data at the computer system that collects data obtained from a plurality of sources; and
(b) providing a network location where the user may track the status of the issue.

3. The method as recited in claim 1, wherein the event is generated when the user activates a GUI object presented in the program; and
wherein allowing the user to generate an event includes providing a class from which the GUI object may be instantiated.

4. The method as recited in claim 1, wherein the program is a Web browser and the user generates the event by activating a GUI object presented on a hypertext document.

5. The method as recited in claim 1, wherein collecting a set of data includes identifying a string of text selected by the user with an input device.

6. The method as recited in claim 1, wherein collecting the set of data includes presenting a menu that contains selectable menu items for categorizing the issue.

7. The method as recited in claim 1, further comprising using the contextual data to identify an entity that is responsible for the content selected by the user.

8. The method as recited in claim 1, wherein the contextual data collected includes a resource identifier for the content selected by the user.

9. The method as recited in claim 1, wherein the contextual data collected includes:
(a) the identity and version of the operating system installed on the computer associated with the user; and
(b) the identity of the program and version that presented the content that was selected by the user.

10. The method as recited in claim 1, wherein the contextual data collected includes files, dialogs, or strings that are associated with the content selected by the user.

11. In a networking environment with a central server computer that is communicatively connected to a plurality of client computers, a software system that aggregates feedback generated at the client computers in a central location, the software system comprising:
(a) a feedback routine associated with the client computers that is operative to:
(i) obtain feedback data that describes an issue with content presented to the user;
(ii) cause the feedback data to be communicated from a client computer to the central server computer;
(b) a backend database associated with the central server computer that stores data obtained from the client computers; and
(c) a database application associated with the central server computer operative to manage and filter data stored in the backend database.

12. The software system as recited in claim 11, further comprising an operating system associated with the client computers that are operative to:
(a) manage the execution of a program; and
(b) allow the program to instantiate a selectable GUI object that initiates execution of the feedback routine when selected.

13. The software system as recited in claim 11, wherein the operating system includes a transport level communication system; and
wherein the feedback routine uses the transport level communication system to cause the feedback data to be communicated from a client computer to the central server computer.

14. The software system as recited in claim 11, further comprising a Web portal associated with the central server computer that is operative to:
(a) receive feedback data from the client computer and store the feedback data in the backend database; and
(b) provide a network location where the user may track the status of the issue.

15. The software system as recited in claim 11, wherein the feedback routine is further configured to collect data that:
(a) identifies the content selected by the user; and
(b) describes a software state of a client computer.

16. The software system as recited in claim 15, wherein the database application is further configured to map the content selected by the user to an entity that is responsible for the content.

17. A computer-readable medium containing computer-readable instructions that when executed in a computer networking environment with a computer system that collects data from a plurality of sources and a computer associated with a user, performs a method of obtaining feedback from the user, the method comprising:
(a) receiving notice that a GUI object was selected;
(b) causing the user to identify the content in which feedback will be provided;
(c) obtaining a description of the issue from the user regarding the content;
(d) communicating a set of data from the computer associated with the user to the computer system that collects data from a plurality of sources; and
(e) wherein the set of data includes:
(i) contextual data from which the source of the content may be identified;
(ii) content identified by the user; and
(iii) description of the issue.

18. The computer-readable medium as recited in claim 17, further comprising:
(a) receiving the set of data at the computer system that collects the data from a plurality of sources; and
(b) providing a network location where the user may track the status of the issue.

19. The computer-readable medium as recited in claim 18, wherein the contextual data communicated from the computer associated with the user to the computer system that collects data from a plurality of sources further includes:
(a) a resource identifier for the content selected by the user.
(b) the identity and version of the operating system installed on the computer associated with the user;
(c) the identity of the program and version that presented the content that was selected by the user; and
(d) the identity of files, dialogs, or strings that are associated with the content selected by the user.

20. The computer-readable medium as recited in claim 17, wherein the GUI object is presented on a Web page and the user generates the event by performing a pointer activation event on the GUI object.
